(19) United States
(12) Patent Application Publication
(10) Pub. No.: US 2006/0136706 A1
(43) Pub. Date: Jun. 22, 2006

(54) Product configuration during boot process

(76) Inventors: Michael Scott Montgomery, Boise, ID (US); Kim R. Chournos, Boise, ID (US); Kevin J. O'Neill, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/020,703

(22) Filed: Dec. 22, 2004

(51) Int. Cl. G06F 9/24

(52) U.S. Cl. 713/2

(57) ABSTRACT

A boot process for a product is initialized. During the boot process, an early configuration signal is recognized, and the boot process places the product into a receive information data mode. Received information is processed to modify information stored with the product.

### BACKGROUND

Products, such as printers are manufactured with many different configurable software settings and optional accessories. The configurable software settings and optional accessories can be configured after the printer leaves the manufacturing location.

Prior methods of modifying settings included fully booting the printer to a ready state, and sending a configuration command to the printer. The configuration command either included changes to be stored on memory within the printer or on a printer circuit board. Printer firmware could also be upgraded by sending a remote firmware upgrade file to the printer. The printer then needed to be rebooted for the changes or upgrades to take effect. This process took a significant amount of time, especially when several printers needed to be reconfigured.

In another prior method, NVRAM on the printer was initialized, either via a special button sequence on the printer, or after a printer operating system was fully booted.

Bootup time for a printer can be a very costly part of the supply chain for printers, as it takes a significant amount of time when compared to the actual process of configuring the printer.

### BRIEF DESCRIPTION OF THE DRAWINGS

FIG. 1 is a block diagram of a printer coupled to a host system, according to an example embodiment.

FIG. 2 is a flow chart illustrating a printer configuration method, according to an example embodiment.

FIG. 3 is a flow chart illustrating a host interacting with a printer, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

A printer 100 is coupled to a host system 110 in one example embodiment to provide for updating of configuration information in the printer 100. Printer 100 has at least one input/output (I/O) channel 115 that is coupled to the host system 110. The printer also comprises a processor or central processing unit (CPU) 120 coupled to the I/O channel 115, and a memory device 125 that is coupled to both the I/O channel 115 and CPU 120 for transfer of data stored on the memory device 125. In one embodiment, memory device 125 contains a storage area 130 that retains data when not connected to a power supply. One example of such a storage area includes non-volatile random access memory (NVRAM). The NVRAM may be soldered in place on a circuit board containing electronic components, such as the I/O channel 115 and CPU 120 or may be part of an integrated circuit in a single module. Many other methods of arranging of the electronic components may be utilized.

In further embodiments, further storage devices may be coupled to the CPU and/or I/O channel, such as a disk drive device for permanently storing data, such as an operating system used by the CPU to control the printer 100. The operating system may also be stored in any other type of persistent media, such as storage 130, or memory 125 provided such memory is persistent. Printing elements are not expressly shown, but may be considered to be represented by printer 100 in the figure.

Upon initializing a boot up process, such as by turning on power to the printer 100, a boot loader program stored in a non-volatile area of memory 125, such as storage 130 begins a process of loading the operating system. The bootloader program also initiates use of configuration information stored in persistent memory to customize or configure the operating system so that the printer operates as desired. Configuration information may be related to configurable items that include, but are not limited to built-in-duplexing, speed selection, local area network (LAN) support, toner enhancement services, disk utilities and others. In one embodiment, the configuration file is 16 hex bytes, but this may be varied as desired. The loading and configuration of the operating system of the printer can take a significant amount of time.

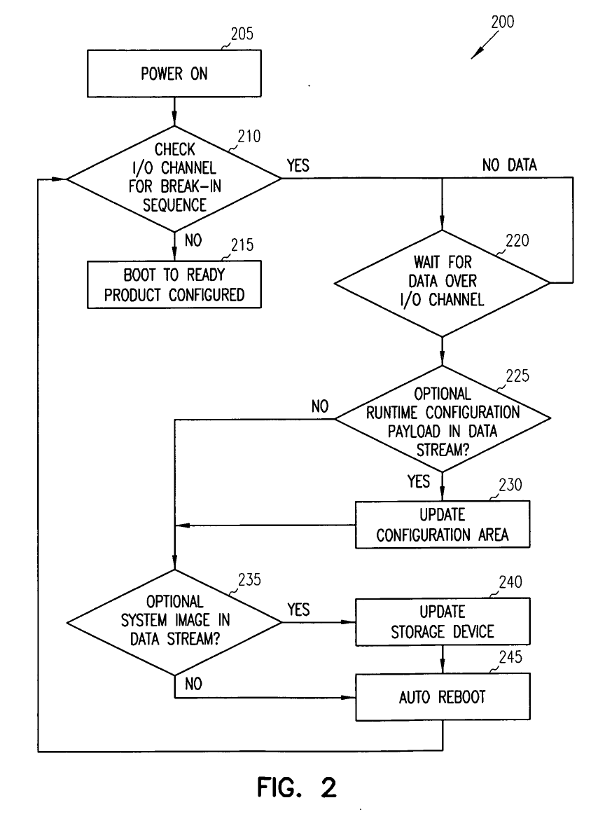

FIG. 2 is a flowchart that illustrates a process 200 for interrupting the bootloader program prior to the operating system being fully loaded. It then allows for updating of configuration information such as a configuration file or firmware image, which can be used to configure the printer to both operate in a desired manner and to take advantage of optional accessories that may be installed and not reflected in prior saved configuration information.

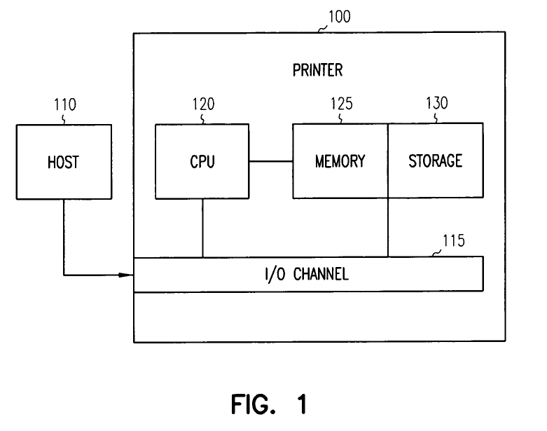

The bootloader program is initialized, such as by turning on power to a product at 205. In one embodiment, the product is a printer having electronics similar to that shown in FIG. 1. The bootloader program runs or executes on the CPU 120 out of memory 125 or storage 130. A check is made at 210 to determine if a break-in sequence is present. The break-in sequence is a predetermined signal, referred to as a special signal that may be provided by an external device, such as host 110. In one embodiment, the signal is applied or provided to I/O channel 115 prior to initialization of the bootloader program so that it is present early in the bootloader process. If no break-in sequence is detected, the bootloader continues a boot up sequence the product to a ready configured state using existing configuration information.

The break-in signal may vary depending on the type of I/O channel 115. In one embodiment, if a parallel I/O channel 115 is employed, the break-in signal may be in the form of pulses sent from the host 110 on a predetermined line to printer 100. The printer 100 may respond with pulses on a line. These types of signals on these lines of the I/O channel may not be seen during normal operations such that they are distinguishable and interpreted to interrupt the bootloader program.

In a Universal Serial Bus (USB) I/O channel 115, an (I/O control) IOCNTRL byte may be provided by the host 110 and recognized by the bootloader as an interrupt. In a LAN type of environment, a normally unused port may be used to look for encrypted packets serving as a break-in signal. Other methods may be used for each of these flavors of I/O channels, and other types of I/O channels may also be used.

If the break-in sequence is detected at 210, the bootloader halts the boot up sequence, and enters a secured receive data mode. It may also send an acknowledgement. The data may be provided over the I/O channel 115, or any other type of connection available. At 220, the data is waited for until received. If the data is an optional runtime configuration payload that is detected in a data stream at 225, the payload is written into a configuration area of persistent memory at 230. A command data file may also be included with the runtime configuration payload that consists of commands that may be stored in persistent storage that may be executed the next time the product 100 is booted. In one embodiment, the data contains checksum and valid bytes that are wrapped in PJL (Printer Job Language) with a total byte checksum added to a header of the data.

If data in the data stream is optional system image, indicative of installed options on the product as detected at 235, a system image in persistent memory or storage is updated at 240. This type of data may also be referred to as a firmware image. The firmware image may be received in a deflated PJL wrapped remote firmware upgrade file. Upon storing either or both types of new data, the product 100 begins to automatically reboot as indicated at 245, which starts the process over at 210, where the I/O channel 115 is checked for further break-in sequences. A reboot command may also be used to manually reboot the product 100.

In one embodiment, a configuration payload is in the form of a tuple comprising a channel designation or command that may be used to identify a persistent storage device. There may be several channels, and each channel in one embodiment correlates to a predetermined area of persistent storage. An offset into the storage device identifies where to store a value that is also included in the payload. In further embodiments, different methods of identifying storage locations may be used, such as absolute addresses without the use of specific channel and offset identifiers. The configuration payload may consist of several tuples received in a serial or parallel manner.

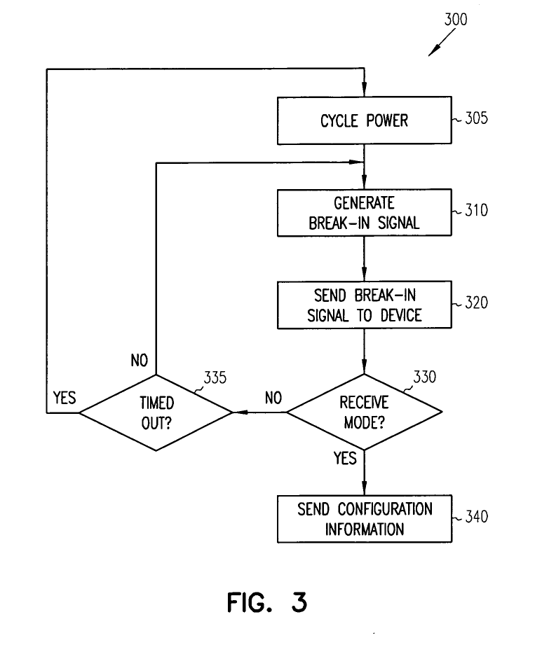

Host 110 (FIG. 1) interacts with a device such as printer 100, according to an example process illustrated by flowchart 300 in FIG. 3 At 305, power is cycled for the printer by the host 10 by powering the printer down and on. Host 110 then generates a break-in signal at 310. The break-in signal is sent at 320 to the printer via I/O channel 115. It may be sent prior to powering on or otherwise rebooting the printer 100 and held on the I/O channel until received by the bootloader program. Power is provided to the printer 100 to initialize the boot process. Power may be provided by a human using a power switch, or by the host utilizing a power on type of signal. The break-in signal may also be provided after power on or otherwise rebooting the printer 100 to interrupt the bootloader early in the boot process. It is determined at 330 that the printer 100 has entered a receive information mode. This may be done by receiving an acknowledgement signal from the printer 100, or by waiting a predetermined amount of time, and assuming that the printer 100 is in such a mode. If the printer 100 is not in the receive mode, the host checks to determine whether it has timed out at 335, and if so, may return to block 305 to cycle power and then generate the break-in signal at 310 again. If no time out has occurred at 335, the break-in signal is generated at 310 again without cycling power.

Once the printer is in a receive information mode, the host 110 sends configuration information to the printer at 340. The configuration information may be in the form of configuration files, or a firmware image. The information itself may be manually entered or received from another source, such as a database containing desired configuration settings and options.

The ability to more quickly change configuration files on a product such as a printer facilitates the ability to use a common code base, such as operating system code for printers that have many different options and capabilities such as duplexing, color tables, and toner controls. Some printer engines have the capability to operate at different page per minute printing speeds. A single code base can be used to operate the printer at the different speeds, with the speed being controlled by one or more values in the configuration data stored with the printer. Configuration data may be used to store many different run time options in current and future products.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method implemented in a product comprising:
initializing a boot process;
recognizing an early configuration signal during the boot process;
entering a receive information data mode in response to the early configuration signal; and
processing information to modify information stored with the product.

2. The method of claim 1 wherein the information comprises product configuration information.

3. The method of claim 2 wherein the configuration information specifies configurable items selected from the group consisting of built-in-duplexing, speed selection, local area network (LAN) support, toner enhancement services, disk utilities.

4. The method of claim 1 wherein the information comprises a firmware image.

5. The method of claim 1 wherein the early configuration signal comprises a break-in sequence.

6. The method of claim 1 wherein the information comprises a tuple specifying a storage location and a value.

7. The method of claim 6 wherein the information comprises a checksum.

8. The method of claim 6 wherein the information comprises multiple tuples.

9. A product implemented method comprising:
initializing a boot process;
receiving a break-in signal during the boot process;
stopping the boot process;
entering a receive information data mode;
receiving information; and
processing the received information.

10. The method of claim 9 wherein processing the received information comprises:
if the information is a runtime configuration payload, updating a configuration storage area with configuration information in the payload; and
if the information is an operational system image, updating a stored firmware image.

11. The method of claim 10 and further comprising reinitializing the boot process after the received information has been processed.

12. The method of claim 10 wherein the configuration information specifies configurable items selected from the group consisting of built-in-duplexing, speed selection, local area network (LAN) support, toner enhancement services, disk utilities.

13. The method of claim 10 wherein the configuration information comprises a tuple specifying a storage location and a value.

14. The method of claim 13 wherein the configuration information comprises a checksum.

15. The method of claim 13 wherein the configuration information comprises multiple tuples.

16. The method of claim 10 wherein the firmware image comprises a PJL wrapped firmware upgrade file.

17. The method of claim of claim 9 wherein initializing the boot process comprises powering on the product.

18. A computer readable medium having machine executable code for causing a machine to implement a method, the method comprising:
initializing a boot process;
receiving a break-in signal during the boot process;
stopping the boot process;
entering a receive information data mode;
receiving information; and
processing the received information.

19. The computer readable medium of claim 18 wherein processing the received information comprises:
if the information is a runtime configuration payload, updating a configuration storage area with configuration information in the payload; and
if the information is an operational system image, updating a stored firmware image.

20. The computer readable medium of claim 18, wherein the method further comprises reinitializing the boot process after the received information has been processed.

21. A method of updating information stored with a printer, the method comprising:
generating a break-in signal;
sending the break-in signal to the printer;
initializing a boot process on the printer;
determining that the printer has entered a receive information mode; and
sending configuration information to the printer.

22. The method of claim 21 wherein the configuration information comprises a runtime configuration payload or a firmware image.

23. The method of claim 21 wherein the break-in signal is sent to the printer prior to completion of the boot process.

24. The method of claim 21 wherein the break-in signal is sent to the printer prior to initialization of the boot process.

25. A printer comprising:
a processor;
a memory, including non-volatile memory;
an operating system stored in the memory; and
a bootloader stored in the memory, wherein the bootloader comprises code for executing on the processor to implement a method comprising:
initializing a boot process;
recognizing an early configuration signal during the boot process;
entering a receive information mode in response to the early configuration signal; and
modifying information stored in the non-volatile memory.

26. The printer of claim 25 and further comprising an I/O channel coupled to the processor and memory, wherein the configuration signal is provided over the I/O channel.

27. The printer of claim 25 wherein the non-volatile memory comprises NVRAM.

28. The printer of claim 25 wherein the method further comprises:
if the information is a runtime configuration payload, updating a configuration storage area with configuration information in the payload; and
if the information is an operational system image, updating a stored firmware image.

29. The printer of claim 25, wherein the method further comprises reinitializing the boot process after the received information has been processed.

30. A product comprising:
means for initializing a boot process;
means for entering a receive information data mode in response to an early configuration signal; and
means for processing information to modify information stored with the product.

31. The product of claim 30 wherein the information comprises product configuration information.

32. The product of claim 31 wherein the configuration information specifies configurable items selected from the group consisting of built-in-duplexing, speed selection, local area network (LAN) support, toner enhancement services, disk utilities.

33. The product of claim 30 wherein the early configuration signal comprises a break-in sequence.

34. The product of claim 30 wherein the information comprises a tuple specifying a storage location and a value and a checksum.
